(19) United States
(12) Patent Application Publication
(10) Pub. No.: US 2012/0086938 A1
(43) Pub. Date: Apr. 12, 2012

(54) Analysis of an Acoustically Separated Liquid

(75) Inventor: Jacob Riis Folkenberg, Hilleroed (DK)

(73) Assignee: FOSS ANALYTICAL A/S, Hilleroed (DK)

(21) Appl. No.: 13/376,402

(22) PCT Filed: Jul. 13, 2009
(86) PCT No.: PCT/EP2009/058891

§ 371 Date: Dec. 6, 2011

(51) Int. Cl. G01N 1/10

(52) U.S. Cl. 356/246

(57) ABSTRACT

An analyser is provided comprising a sample chamber for holding a liquid sample containing particles and an ultrasound source acoustically couplable to the sample chamber to supply resonant ultrasound energy for acoustically concentrating particles in the liquid sample in nodal planes established thereby. A probe is also provided which is adapted to supply electromagnetic energy into the sample chamber and to receive the supplied electromagnetic energy from the sample chamber at least during a time at which particles are substantially concentrated in associated nodal planes. The analyser is provided with an analysis unit in operable connection to a detector of the optical probe and is adapted to determine one or both a quantitative and a qualitative property of the liquid sample from the received electromagnetic energy.

The present invention relates to the analysis of an acoustically separated liquid sample. In particular the present invention relates to a method of and an analyser for the analysis of an acoustically separated liquid sample using electromagnetic radiation.

The analysis of liquid samples is of interest to a variety of industries and fields, such as the food; feed; beverage; pharmaceutical and petrochemical industries and in the medical field, where analysis typically is performed using electromagnetic radiation to probe the sample and is detected after its interaction with the sample. Analysis may be made on raw, intermediate or finished products. A dairy farmer, for example, may wish to analyse milk for the presence of somatic cells or bacteria in order to monitor the health of the herd or to limit the number of such particles in bulk milk delivered to dairies. In the medical field cell counting is often used in the analysis of human milk, blood, urine or other biological liquids where the amount and type of cells, such as somatic cells, red and white blood cells, are measured. The presence of, for example, yeast cells and certain bacteria cells are of interest to the beer, wine and fruit juice industries. In other types of analysis of liquid samples the characteristic compositional properties of the liquid is determined, such as by using infrared spectroscopy or other spectrographic measurement techniques.

In such analysis the presence of unwanted particles in the liquid sample may interfere with the measurement technique. Fat particles, in milk for example, or pulp in fruit juice or wine may produce significant scatter of the electromagnetic radiation employed to probe the sample. This adversely affects the accuracy or applicability of these measurement techniques.

It is therefore desirable to avoid unwanted particles in the liquid sample interfering with the analysis.

It is known from EP 1365849 of Laurell et al. to provide a device and a method for separating particles from fluids having a laminar flow using ultrasound and stationary wave effects comprising a micro-technology channel system, preferably formed in silicon, with an integrated branching point or branching fork, and a single ultrasound, preferably a piezoelectric, source. In use, low density fat globules tend to be moved towards ultrasound pressure wave anti-nodes whilst the more dense particles, such as somatic cells, tend to be moved towards ultrasound pressure wave nodes. Hence the particles in the liquid sample become acoustically concentrated in related nodal planes as the sample flows through the channel system. A suitable branching configuration of the channels permits the fat to be separated from the flowing liquid to leave a flowing liquid sample containing predominantly only those particles to be subsequently analysed using an appropriate optical probe. One problem with this known method and device is that fat globules tend to stick to the walls of the channels which increases the risk of a blockage or a disturbance of the flow.

In order to overcome this problem it is known from our co-pending application PCT/EP/2008/063434 to provide a device for the separation of particles in a flowing sample liquid which comprises a source of ultrasound capable of emitting ultrasound with a given wavelength into a compartment of a flow channel system, which compartment is dimensioned to support a standing ultrasonic wave of said wavelength and is of sufficient length in the flow direction to provide sufficient interaction between the ultrasound wave and the flowing liquid. Particle separation within the flowing liquid is achieved substantially as described above with respect to the device and method of EP 1365849. The device further comprises an additional inlet configured to direct a sheath liquid to extend substantially in parallel to an anti-node plane of the ultrasonic standing wave proximate to a sheathed compartment wall. Specifically the device is intended for use in combination with a particle counting device for counting somatic cells in milk. A probe such as a fluorescent counter and an electrical probe such as a coulter counter are provided as examples of suitable particle counting devices. In this intended use fat globules become entrained in the flowing sheath liquid and do not come into contact with the walls of any of the channels in which the sample liquid flows. However, such an arrangement requires additional flow control and still requires that the channel in which separation occurs is sufficiently long, in the direction of flow, to permit significant interaction between the flowing liquid and the ultrasound wave.

According to a first aspect of the invention there is provided an analyser comprising a sample chamber for holding a liquid sample containing particles, which sample chamber is internally dimensioned to support an ultrasound standing wave; an ultrasound source acoustically couplable to the sample chamber to supply resonant ultrasound energy thereto for acoustically concentrating particles in the liquid sample in nodal planes established thereby and a probe adapted to supply electromagnetic energy, such as ultraviolet, visible and/or infra-red light energy (separately or in any combination referred to as ‘optical’ energy), into the sample chamber and to receive the supplied electromagnetic energy from the sample chamber. The analyser is adapted to determine one or both a quantitative and a qualitative property of the liquid sample predominantly from the electromagnetic energy received at a time the particles are concentrated substantially in the nodal planes. The progressive change in pressure amplitude in a direction transverse the chamber exhibited by the standing wave is such that particles within the liquid sample, such as say fat particles in a milk sample, are concentrated in specific regions of the chamber, as determined by the standing wave. In this manner the interference of these particles upon measurements using the probe, such as say counting of somatic cells in or performing an analysis of a specific region of the electromagnetic spectrum from a milk sample, within the sample volume is reduced. Moreover, as the particles are not removed from the sample the sample chamber and any flow system associated with the analyser may be made less complicated particularly since no sheath liquid or branched channel structures are necessary.

Usefully, the liquid sample is held at a standstill during exposure to the ultrasound. Consequently its interaction with the ultrasound standing wave may be increased without increasing the length of the sample chamber.

In order to extend the time during which particles remain concentrated substantially in associated nodal planes the ultrasound source may be operated in a first mode, to supply the ultrasound radiation at a first, relatively high amplitude, then operated in a second mode, to supply the ultrasound radiation at a second relatively low amplitude. During the first mode of operation particles are focussed in associated nodal planes and during the second mode of operation particles tend to be maintained in these planes. Thus the particles will remain concentrated in the associated nodal planes for longer whilst the energy consumption of the ultrasound source is reduced.

These and other advantages will be better appreciated from a consideration of the following descriptions of exemplary embodiments of the present invention made with reference to the accompanying figures, of which:

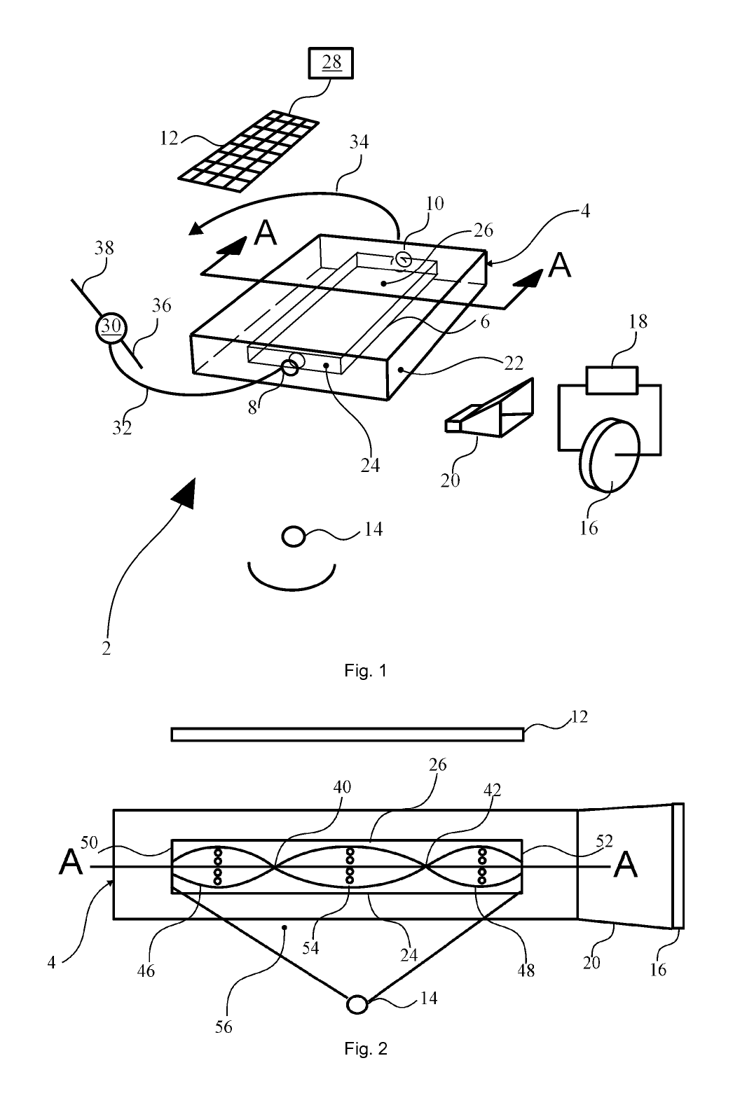

FIG. 1 illustrates a first embodiment of an analyser according to the present invention;

FIG. 2 illustrates the embodiment of FIG. 1 including a cross-sectional view of the sample cuvette along the lines A-A of FIG. 1;

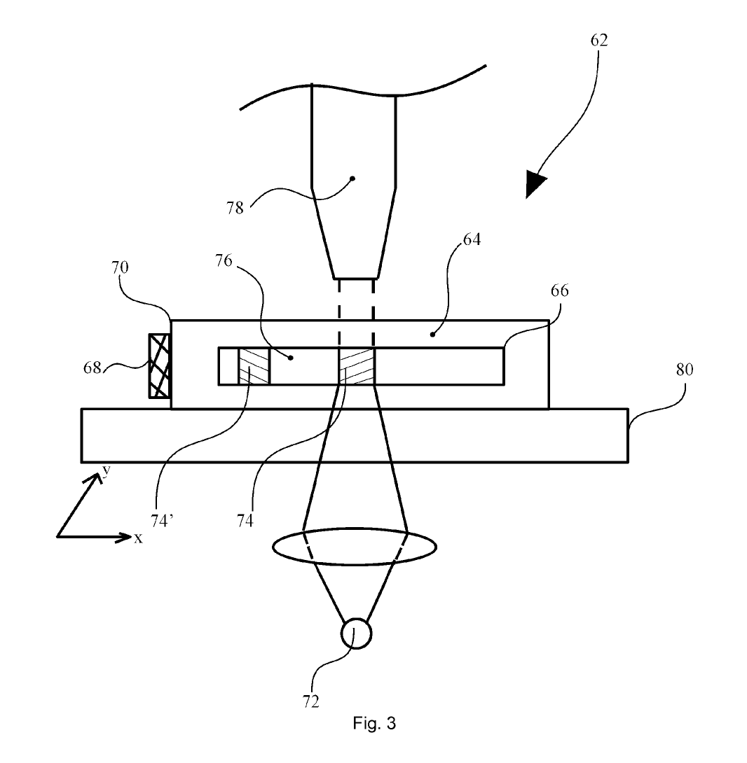

FIG. 3 illustrates a second embodiment of an analyser according to the present invention;

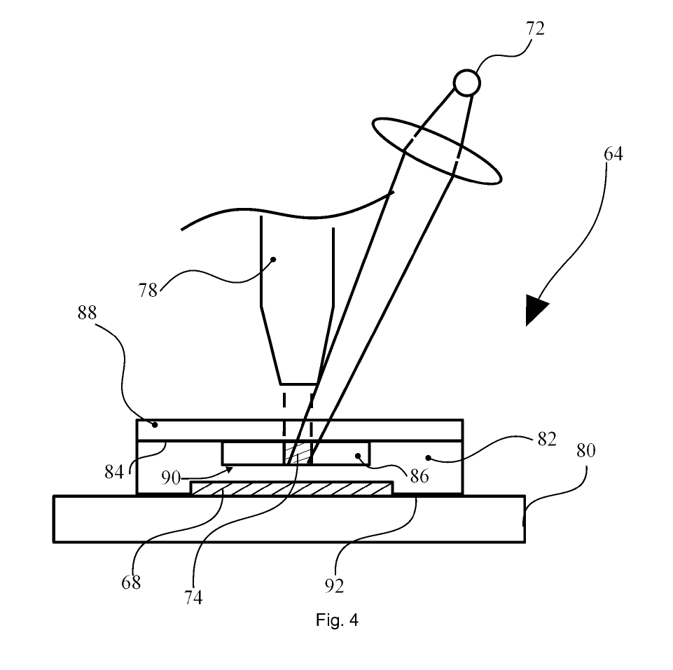

FIG. 4 illustrates a modification to the analyser of the second embodiment;

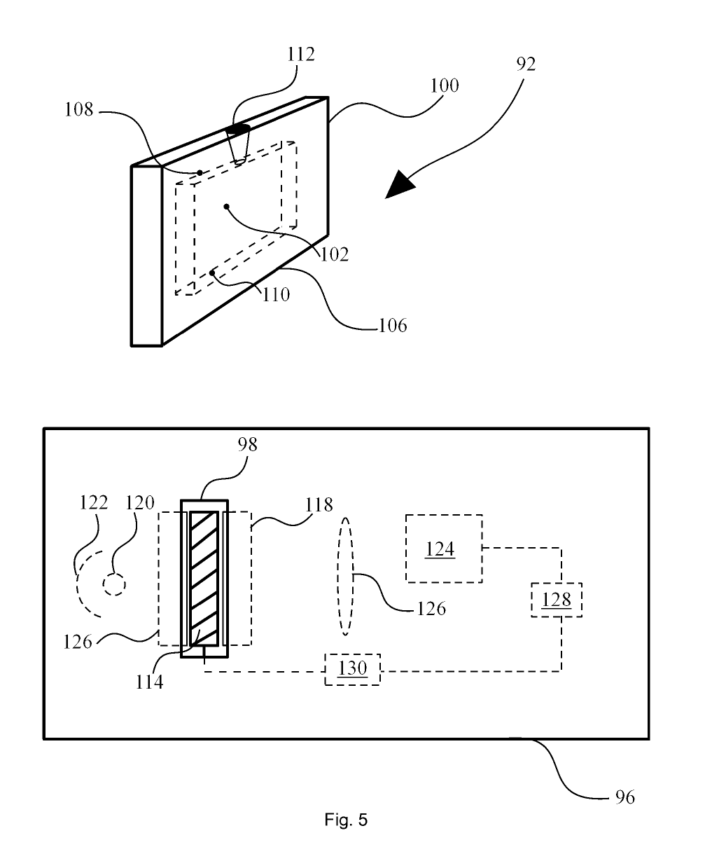

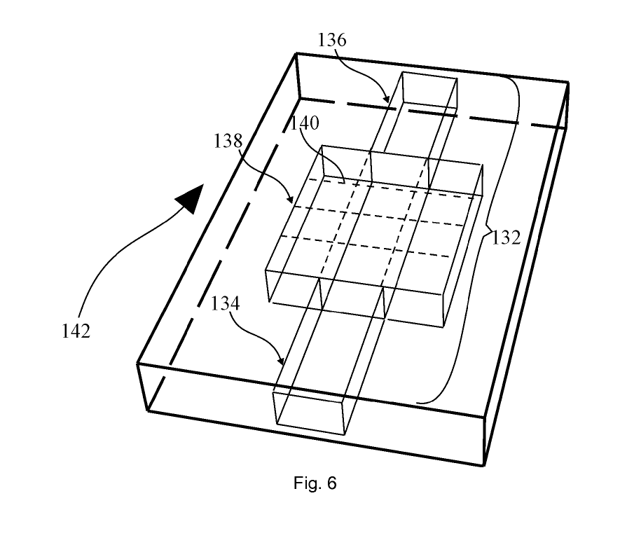

FIG. 5 illustrates a third embodiment of an analyser according to the present invention; and

FIG. 6 illustrates an alternative embodiment of a cuvette usable in the analyser according to the present invention.

Considering now FIG. 1, the analyser 2 according to the present invention is here illustrated in an ‘exploded’ view for the sake of clarity and comprises a cuvette 4 formed with a sample chamber 6. In the present embodiment an inlet 8 and an outlet 10 is provided for connecting the sample chamber 6 to external the cuvette 4. In the present embodiment the cuvette 4 is made wholly from a transparent material (i.e. transparent to at least the wavelengths of electromagnetic energy employed), such as fused silica or other glass in which the sample chamber 6 has been formed.

Alternatively, such a cuvette 4 may be formed from non-transparent material and provided with windows or a transparent lid/base to permit optical coupling of a probe 12,14 to the sample chamber 6.

The analyser 2 also comprises an acoustic source 16, here in the form of a piezo-electric element but other acoustic sources, such as magnetostrictive or electromagnetic transducers may substitute for the piezo-electric element 16. A signal generator 18 is provided to drive the source 16 to generate acoustic energy which is resonant with the sample chamber 6. In this manner a standing wave may be established, as described in more detail with reference to FIG. 2.

An acoustic horn 20 is provided in the present exemplary embodiment to couple acoustic energy generated by the source 16 into the sample chamber 6 but may be omitted in other embodiments. As illustrated the horn 20 is intended for coupling via a side wall 22 of the cuvette 4. This has an advantage that in the present configuration physical interference with the electromagnetic energy supplied by the probe 12,14 is avoided.

The position of the acoustic source 16 is not critical, as long as the coupling of the ultrasound into the channel is efficient. The source 16, for example, may be placed at the side or even on top of the cuvette 4. Moreover, as mentioned above, the use of the acoustic horn 20 is not essential. A contact material between the acoustic source 16 and the cuvette 4 may be employed as necessary to match the acoustic impedances of the transducer and the cuvette material.

The probe 12,14 here comprises a supply 14 of optical energy configured to illuminate substantially all of a bottom surface 24 of the sample chamber 6 and a large area spatial detector 12, such as a conventional diode array or charge coupled device (CCD) (illustrated by cross hatch of 12) detector, which is located facing a top surface 26 of the sample chamber 6, opposing the bottom surface 24 and adapted to image in a known manner substantially the entire volume of the sample chamber 6 and its contents in a single exposure. Thus, in the present exemplary embodiment the optical probe 12,14 is configured to make transmission measurements.

An image analyser 28 is operably connected to the detector 12 to, in use, receive a signal representative of the image recorded by the detector 12 and analyse it in a conventional manner to determine the quantity of particles within the volume of a sample fluid held in the sample chamber 6. Additionally or alternatively quality parameters of particles, such as size, may be determined by the analyser 28. Thus the optical probe 12,14 and the analyser 28 are configured as a conventional particle detector known in the art.

A pump system 30, such as may be formed using a known peristaltic or syringe pump, is provided as a part of the analyser 2 according to the present embodiment and connects to the inlet 8 of the sample chamber 6 via an inlet tube 32. An outlet tube 34 is also provided to couple the outlet 10 of the chamber 6 to waste. A sample feed 36 line and, as illustrated in the present exemplary embodiment, an optional flushing liquid line 38 are also provided in fluid connection with the pump system 30.

The pump system 30 is configured to operate so that in use a volume of liquid sample may be pumped via the sample feed line 36 and inlet tube 32 into the sample chamber 6 and held there whilst acoustic energy from the acoustic source 16 is supplied to it. The acoustic source 16 and the optical probe 12,14 are adapted to operate in a timed relationship such that only after the acoustic separation of particles from within the volume of the liquid sample in the sample chamber 6 a quantitative and/or qualitative assessment of the particles remaining within the volume of the liquid sample is made using the optical probe 12,14. The pump system 30 is then operated to remove the sample from the sample chamber 6 to waste via the outlet tube 34, for example by its displacement from the chamber 6 by a new sample. The volume of liquid sample provided by the pump system 30 at each sampling instance may be selected to be larger than the volume of the sample chamber 6 so that the excess liquid sample may be used to flush the analyser 2 and avoid (or at least reduce the risk of) cross-contamination between samples. Additionally or alternatively an optional flushing liquid may be provided, for example as illustrated in the present exemplary embodiment via the flushing liquid line 38, and the pump system 30 then operated to flush the analyser 2 with flushing liquid in order to mitigate cross-contamination between samples.

Considering the illustration of the analyser 2 of FIG. 1 which is shown in FIG. 2 and which includes the cross sectional view A-A of the cuvette 4 of FIG. 1. The cuvette 4 or “substrate” has formed into it the sample holder 6 or “channel” using standard formation techniques known to the microelectronics industry. The channel 6 is dimensioned so as to support a higher order ultrasound standing wave, here illustrated as having two nodes 40, 42 inside the channel 6; two anti-nodes 46,48 towards sidewalls 50,52 of the channel 6; and one anti-node 54 located substantially central of the channel between the sidewalls 50,52. These nodes 40,42 and anti-nodes 46,48,54 each forms an associated ‘nodal plane’ in direction perpendicular to the cross-section along the sample chamber 6 in which planes particles in the liquid sample will concentrated according to their density. When used for milk, for example, the lighter density fat particles will tend to be focussed in the anti-node planes associated with the anti-nodes 46,48,54. In this manner interfering particles such as fat (or say pulp in fruit juice) can be removed from the bulk volume of a liquid sample to be analysed by concentrating them in specific regions (here anti-node planes) in the liquid sample where they will remain during the analysis using the optical probe 12,14.

When used for the analysis of whole blood, for example, the white and the red blood cells tend to be concentrated in different nodal planes. In this manner the different types of cells can be readily separated and each type investigated independently using the probe 12,14 with minimum interference from the other types.

As the concentrated particles tend to redistribute themselves relatively slowly after removal of the ultrasound standing wave the optical probe 12,14 may be operated to make measurements for a time after the acoustic source 12 has ceased to supply the resonant ultrasound energy to the sample chamber 6 and during which time the concentrated particles remain substantially in the regions in which the resonant ultrasound had located them. This time may be established empirically in a relatively simple and straightforward manner by monitoring the redistribution of interfering particles throughout the bulk volume of a particular type of liquid sample after the removal of resonant ultrasound energy and determining a suitable time window in which the particles remain substantially concentrated in the related nodal planes. It will also be appreciated that the optical probe 12,14 may be operated substantially continuously in the presence of a sample in the sample chamber 6 and that the image analyser 28 is operated in timed relationship with the application of ultrasound in order to obtain an image for analysis in which unwanted particles remain located in the regions associated with the ultrasound standing wave (here anti-node planes). By way of example only, the width of the band of particles at the related nodal plane could be monitored by the image analyser 28 and image analysis is performed only while the increase in the width (such as, for example, full width half maximum) of the band after removal of acoustic energy is within a predetermined range (say a maximum increase of a factor of 3) of that width determined whilst the acoustic energy was applied.

In an alternative embodiment the acoustic source 12 is operated to deliver ultrasound energy at a first, relatively higher amplitude, during a first period within which particles are concentrated at the related nodal planes and then at a second, lower amplitude for maintaining the particles concentrated in the related nodal planes, during a second period within which the probe 12,14 is operated to generate an image for analysis by the image analyser 28 in order to determine one or both a quantitative or a qualitative property of particles remaining in the bulk of the liquid sample. This multi (here dual) mode operation of the ultrasound source extends the time during which analysis using the probe 12,14 may be performed whilst reducing power consumption of the ultrasound source as well as unwanted heating which may result from the source being operated always at the higher amplitude.

The ultrasound source 16 is, in the present exemplary embodiment, acoustically coupled to the side wall 22 of the cuvette 4 via the acoustic horn 20 so as to be able to deliver resonant acoustic energy in to the sample chamber 6.

The wavelength in the sample liquid, λ, of the ultrasonic energy emitted by the source 16 must be such that the size and shape of the chamber 6 can support a fundamental or higher order (in this embodiment second order) ultrasound standing wave. Thus the chamber 6 of the present embodiment is designed with a width of approximately n(λ/2), where n is the desired order of the standing wave (n=1,2,3 . . . ), and a height of preferably less than λ/2.

In the process of concentrating particles in specific node plane, different harmonics of the standing wave may be utilized, either sequentially or simultaneously. This may be accomplished by using different frequencies to actuate the acoustic source, corresponding to different ultrasound wavelengths. In an exemplary embodiment, an ultrasonic standing wave corresponding to 2×λ/2 is excited at first, which causes some of the fat particles in milk to move towards the centre of the channel. Next, an ultrasonic standing wave corresponding to 1×λ/2 is excited, which causes the same fat particles to move in the opposite direction towards the channel walls. This back-and-forth movement may release other particles that stick to the fat particles.

In practice, most cross sectional shapes of the chamber 6 will support a standing wave at some resonance frequency, even if the walls are not parallel. If the shape is characterized by one direction being significantly longer than the perpendicular direction, the lowest frequency resonance will generate a standing wave pattern extending primarily along the longest direction. The equilibrium positions of particles subjected to the acoustic force in such a chamber 6 will be located in concentrating planes approximately perpendicular to the longest direction, and the concentrating planes will still resemble geometrical planes. The lowest resonance frequency—the so-called fundamental resonance—will give rise to a standing wave pattern with one node plane in the chamber 6. The first higher order resonance will give rise to two node planes in the chamber 6, the second higher order resonance will give rise to three node planes in the chamber 6 and so on.

If the shape of the chamber 6 cross section is not characterized by one direction being significantly longer than the perpendicular direction, e.g. a square or circular shape, a standing wave pattern can still be generated, but the shape of the concentrating planes may no longer resemble an unconnected geometrical plane, but may instead be e.g. a cylindrical surface in a circular chamber 6. Dependent on the position and power of the ultrasonic source, and the properties of the base material more complex standing wave patterns may also be stable in a chamber 6 with a close to regular cross-section.

In another embodiment of the invention, the cross-sectional shape or dimensions are changed along the direction of a through chamber 132 of a cuvette 142. An example of this embodiment is shown in FIG. 6, where a first 134 and a second 136 section of the chamber 132 has a width of λ/2,and a third part 138, between the first 134 and the second 136 parts has a width of 3×λ/2 and a length of 4×λ/2. This third part 138 of the chamber 132 supports a standing ultrasonic wave with a two dimensional pattern of nodal planes 140 and thus causes particles in a sample liquid to be arranged according to this pattern. With a proper choice of magnification, the third part 138 of the chamber 132 may be imaged onto a pixel matrix with an aspect ratio of 4:3, completely filling the field of view. Thus, the largest possible volume of the liquid may be imaged in one exposure.

In the present embodiment, and by way of example only, the optical source 14 is configured to provide a beam 56 of optical energy which will illuminate substantially all of a base 24 of the sample chamber 6 to interact with substantially the entire volume of liquid, such as milk, sample held in the chamber 6 before passing out of the chamber 6 through a top surface 26 of the sample chamber 6, opposite the base 24. The large area detector 12, here comprising a diode array, is arranged and sized to image substantially the entire chamber 6 in a single exposure and is here illustrated as being substantially co-extensive with the chamber 6 in the direction along A-A.

Consider now a second embodiment of an analyser 62 which is illustrated in FIG. 3. Similar to the analyser 2 according to the embodiment of FIG. 1 the analyser 62 comprises a cuvette 64 which is formed of a material transparent to the relevant optical radiation and into which a sample chamber 66 is made. This cuvette 64 and chamber 66 arrangement being substantially the same as that arrangement 4, 6 described with respect to FIG. 1. An ultrasound source 68 is, in this exemplary embodiment, attached directly to a wall, here a side wall 70, of the cuvette 64 to supply resonant ultrasound into the chamber 66.

The optical probe 72,78 of the present embodiment comprises a source 72 of the relevant optical radiation configured to illuminate a portion 74 of the volume of liquid sample 76 and a complementary microscope imaging system 78 configured to image some or all of the illuminated portion 74, largely depending on the depth of focus of the imaging system 78.

The analyser 62 also comprises a conventional x-y table 80 on to which the cuvette 64 is mountable. The x-y table is made movable (here in the x and y directions illustrated in FIG. 3) so as to enable different portions (here exemplified by additional portion 74′) of the sample volume 76 to be imaged at each of a plurality of exposures. In this manner a desired volume, consisting of a plurality of different portions 74, 74′ of the liquid volume 76, may be investigated by means of a conventional image analyser (not shown) operably connected to receive a representation of the image generated by the optical probe 72,78. Satisfactory counting statistics may, in this way, be achieved.

It will be appreciated that means other than the x-y table 80, such as transport arm operably connected to effect movement of the optical probe 72,28, may be employed to provide the relative movement of the cuvette 64 and the optical probe 72,78 for imaging of a plurality of different portions 74, 74′ of the liquid volume 76.

In a modification to the analyser 62 which is illustrated in FIG. 4 the optical source 72 and the microscope imaging system 78 are both located on the same side of the cuvette 64. In this case the cuvette 64 may be formed as an opaque base 82, for example using germanium or silicon, into a top surface 84 of which is etched a channel 86. A transparent lid 88 closes the channel 86 to form a sample chamber 90. It will be appreciated that the lid 88 need only be transparent in a window overlaying at least a portion of the channel 86 to allow optical energy from the source 72 to interact with a liquid sample within the chamber 90 and to be subsequently detected using the microscope imaging system 78.

In this configuration the source of ultrasound 68 may be conveniently located contacting a bottom surface 92 of the cuvette 64. The analyser 62 of FIGS. 3 and 4 may also be provided with a pump system similar to that system 30 of FIG. 1 by which a sample may be automatically introduced into the sample chamber 66,90. Alternatively the sample chamber 66, 90 may be provided with an inlet for connection to a manually operated sample supply/extraction arrangement such a syringe (not shown).

When analysing and/or counting particles within a liquid volume using an analyser 62, 2 according to the present invention the particles to be detected may be unlabelled or could be labelled in a known manner so as to enhance the detection of the desired particles. Detection in some probe configurations may also be enhanced using conventional staining of the particles to increase image contrast. Optical detection by means, such as autofluorescence, epifluorescence or optical scattering, other than by image analysis may also be employed. Moreover, the liquid sample may undergo an incubation process within an incubator of known type in an attempt to increase the number of particles to be counted. Incubation may be done either before or after introduction of the sample into the sample chamber 6,66,90.

A third embodiment of an analyser 92 according to the present invention is illustrated in FIG. 5. The analyser 92 comprises a housing 96 into which an opening, here a slot 98, is formed for removably receiving a sealed cuvette 100 into the interior of the housing 96.

The cuvette 100 is formed at least in part of an optically transparent material and is provided with a sample chamber 102. The sample chamber 102 is dimensioned to support a higher order ultrasound standing wave in a direction substantially perpendicular to a long edge 106 of the cuvette 100. The standing wave, in the present embodiment, is chosen such that anti-node planes extends essentially proximal to and parallel with opposing long walls 108, 110 of the sample chamber 102. Thus lower density particles within a volume of a liquid sample retained in the sample chamber 102 will tend aggregate towards and along the opposing long walls of the chamber 102. A sealing cap or plug 112 is provided in the present exemplary embodiment with which to seal an inlet (not shown) of the cuvette 100 by which inlet a liquid sample is introduced into the sample chamber 102. In other embodiments the plug 112 and associated inlet may be omitted and the sample chamber 102 provided as a through channel in the cuvette 100. In this alternative embodiment the liquid sample is introduced into the sample chamber 102 and subsequently retained therein by capillary action.

The cuvette 100 may conveniently be made a single-use cuvette to be discarded after analysis and sealing could be achieved using other known techniques.

The cuvette 100 is externally dimensioned to slidably contact the internal walls of opening 98 as it is received into the housing 96.

An ultrasound source 114 is situated at the base of the opening 98 and is acoustically coupled, here by direct contact, to the cuvette 100 when the cuvette 100 is fully received in the opening 98.

A lid (not shown) may be provided in connection with the opening 98 so as to, when closed, optically isolate the cuvette 100 from unwanted light sources external the housing 96.

Also provided in connection with the opening 98 and internal the housing 96 are first 116 and second 118 optical windows. The first window 116 is disposed within the opening 98 so as to allow optical energy from a light source 120 (here illustrated together with an associated parabolic reflector element 122) to pass into the sample chamber 102 of a received cuvette 100. In the present embodiment the second optical window 118 is disposed within the opening 98 opposing the first window 116 so as to allow optical energy from the light source 120 which has interacted with a liquid sample within the sample chamber 102 of the received cuvette 100 to pass to a detector 124 (here via focussing optic 126). Thus, in the present embodiment the optical probe 120,124 is configured as a transmission type probe but other known configurations such as reflectance and transflectance type probes may be employed in the alternative with suitable alteration to the windows 116,118.

In the present embodiment the detector 124 comprises a photo-spectrometer device, such as a scanning or fixed monochromator or a Fourier Transform interferometer, configured to generate an output signal dependent on the intensity of optical energy of know or determinable wavelength that is received from the liquid sample. An analyser 128 is connected to receive the output from the detector 124 and to generate a quantitative and/or a qualitative measurement of the composition of the liquid sample. The analyser 128 may, in a known manner, be configured to apply for example multivariate statistical analysis to the received output or to generate a measurement based on a comparison of the received output with stored spectra representing samples of known composition.

The analyser 128 is, in the present embodiment, also configured to control the operation of a signal generator 130 used to energise the ultrasound source 114 to produce ultrasound and to control the optical probe formed by the light source 120 and the detector 124 to operate after the start of the application of ultrasound energy to the sample, either during or after its application. In this manner unwanted particles within the bulk of the liquid sample are caused to aggregate in regions of the sample defined by anti-nodal or nodal planes of the ultrasound standing wave and their interference on measurements made using the optical probe 120,124 is thus significantly reduced.

It will be appreciated that the cuvette 100 may be replaced with a reusable cuvette, usefully attached to a flow system for introduction and removal of a liquid sample. Furthermore the optical probe 120, 124 may be replaced with a probe adapted to count and/or qualify (for example by size) particles within the volume of the sample, such as the probes 12,14 or 72,78 exemplified by the embodiments described with respect to FIG. 1 FIG. 3, and FIG. 4 above.

1. An analyser (2;62;92) comprising a sample chamber (6;66;90;102;132) for holding a liquid sample containing particles; an ultrasound source (16;68;114) acoustically couplable to the sample chamber (6;66;90;102;132) to supply resonant ultrasound energy thereto for acoustically concentrating particles in the liquid sample in nodal planes (40,42,46,48,54;140) established thereby and a probe (12,14;72,78;120,124) adapted to supply electromagnetic energy into the sample chamber (6;66;90;102;132) and to receive the supplied electromagnetic energy radiated from the sample chamber (6;66;90;102;132) characterised in that the analyser (2;62;92) is adapted to determine one or both a quantitative and a qualitative property of the liquid sample in the sample chamber (6;66;90;102;132) from the electromagnetic energy received at a time the concentrated particles remain substantially in the associated nodal planes (40,42,46,48,54;140).

2. An analyser (2) as claimed in claim 1 characterised in that the sample chamber (6) is formed with an inlet (8) and an outlet (10) and in that the analyser (2) further comprises a pumping system (30) operable to regulate a flow of sample through the sample chamber (6) to achieve standstill.

3. An analyser (2;62;92) as claimed in claim 1 or 2 characterised in that the probe (12,14;72,78;120,124) is an optical probe adapted to supply and to receive optical energy.

4. An analyser (2;62) as claimed in claim 3 characterised in that the optical probe (12,14;72,78) comprises an imaging device (12;78).

5. An analyser (2) as claimed in claim 4 characterised in that the imaging device (12) is configured to image a desired volume of the liquid sample in a single exposure.

6. An analyser (62) as claimed in claim 4 characterised in that the imaging device (78) is configured to image a desired volume of the liquid sample in a plurality of exposures.

7. An analyser (62) as claimed in claim 6 characterised in that the imaging device comprises a microscope imaging system (78) and in that the microscope imaging system (78) and the sample chamber (66;90) are relative movable so as to image different portions (74,74′) of the desired volume with each exposure of the plurality.

8. An analyser (2) as claimed in any of the claims 4 to 7 characterised in that the analyser further comprises an image analyser (28) operably connected to the imaging device (12) to receive an image and to determine therefrom one or both size and number of particles suspended in the liquid sample.

9. An analyser (92) as claimed in claim 3 characterised in that the optical probe (120,124) comprises a spectrometer (124).

10. An analyser (92) as claimed in Claim lcharacterised in that there is also provided a housing (96) having an opening (98) for releasably receiving the sample chamber(102) in electromagnetic and ultrasonic coupling to the probe(120,124) and ultrasound source (114) respectively.

11. An analyser (2;62;92) as claimed in claim 1 characterised in that the ultrasound source (16;68;114) is adapted to operate sequentially in a first mode to emit ultrasound at a first, relatively higher, amplitude and in a second mode to emit ultrasound at a second, relatively lower, amplitude.

12. A method of analysing a liquid sample containing particles comprising the steps of: introducing the liquid sample into a sample chamber (6;66;90;102;132) acoustically and electromagnetically couplable to an ultrasound source (16;68;114) and a probe (12,14;72,78;120,124) respectively; acoustically concentrating at least some of the particles in nodal planes (40,42,46,48,54;140) established by resonant ultrasound energy supplied to the liquid sample by the ultrasound source(16;68;114); operating the probe (12,14;72,78;120,124) to supply electromagnetic energy into and receive the supplied electromagnetic energy from the liquid sample whilst the concentrated particles remain substantially in the nodal planes (40,42,46,48,54;140); analysing the received electromagnetic energy to determine one or both a quantitative and a qualitative property of the liquid sample.

13. A method as claimed in claim 12 characterised in that the step of supplying and receiving electromagnetic energy consists of supplying and receiving optical energy and in that there is included a further step of generating from the received optical energy an image of a desired volume of the liquid sample.
